(19) United States
(12) Patent Application Publication
(10) Pub. No.: US 2008/0151790 A1
(43) Pub. Date: Jun. 26, 2008

(54) Time division duplex amplifier for network signals

(76) Inventors: Ronald B. Lee, San Diego, CA (US); Edward Warner, San Diego, CA (US)

Correspondence Address: Michael W. Landry, 5098 Seachase Street, San Diego, CA, 92130, US

(21) Appl. No.: 11/613,192

(22) Filed: Dec. 20, 2006

(51) Int. Cl. H04B 1/44

(52) U.S. Cl. 370/282

(57) ABSTRACT

A time division duplex (TDD) amplifier switches direction of amplification to amplify signals in both directions as needed for the direction of signal flow in the network. The TDD amplifier switching is controlled by monitoring the time slot information of the communication channel to determine the schedule of transmissions in each direction. The amplifier direction is switched during the inter-frame gaps of the TDD data transmissions. The TDD amplifier can be used for WAN access to homes and in a LAN operating within a home.

### BACKGROUND

1. Field of the invention

The present invention relates to signal amplifiers for amplification of digital communication signals transmitted over a network.

2. Prior Art

Digital data networks can be formed using coaxial cable wiring. The network can be a wide area network (WAN) or local area network (LAN). An example of a WAN utilizing cable wiring is implemented according to Data Over Cable Service Interface Specification (DOCSIS). A WAN is single point to multipoint communication network; a LAN is full mesh point-to-point. The DOCSIS standard defines interfaces for cable modems involved in high speed data distribution over the wiring infrastructure used for cable television networks. A useful data network requires bidirectional communication so that nodes in the network can send and receive information. Existing networks over cable use different frequency bands, or frequency division multiplexing (FDM), for the upstream and downstream data. Downstream data is transmitted over a television channel frequency that is specifically allocated for digital data instead of a TV signal. The upstream data is generally transmitted below the low end of the traditional cable frequency spectrum of 55-850 MHz. Time division multiple access (TDMA) allows several users to share the same upstream and downstream frequency by dividing it into different timeslots.

For FDM networks, both the downstream and upstream, or return, path require amplifiers to boost the signal to compensate for losses in the communication channel that occur due to dissipative losses in the cable and signal splitters that divide the signal power. The frequencies of operation are designed with separate bands for downstream and upstream signals; therefore, amplifiers are constructed to amplify each frequency band in only one direction.

A LAN can be implemented using the coaxial wiring inside a home or a multiple dwelling unit. Splitters and cabling inside the home cause signal loss and may require amplification of signals. A LAN requires full mesh communication between each node.

Time division duplex (TDD) is a simplex, one-way at a time, communication technique. In a network using TDD, all network node transmissions use the same frequency channel. The shared use of the channel is scheduled or arbitrated to avoid simultaneous transmission that would cause collisions and loss of data. The frequency selective amplifiers used in a conventional cable network amplify in only one direction and do not enable amplification of the TDD signals, which requires amplification in both directions over the cable. The single-direction amplifiers block signals in the band being amplified from passing the opposite direction.

### SUMMARY OF THE INVENTION

A time division duplex (TDD) amplifier switches direction of amplification to amplify signals in both directions as needed depending on the direction of signal flow in the network. The TDD amplifier switching can be controlled by monitoring transmission of the network Media Access Plan (MAP), which is a MAC message sent by a network controller (NC). MAPs are used to coordinate all transmissions and contains the schedule of transmissions in each direction. The amplifier direction is switched during the inter-frame gaps of the data transmissions as scheduled by the MAP.

The network comprises nodes, which provide both PHY (physical) and MAC (medium access control) layers. A node can function as a network controller, which manages the flow of packets on the network via MAPs, or as a client, which follows the transmission schedule sent in MAPs. A node can assume either function. A network generally will contain only one NC node and at least one client node. All nodes can send or receive packets to or from any other node.

A TDD amplifier comprises a direction-switchable RF amplifier, filtering as needed to select the range of frequencies amplified, and control circuitry to select the direction and gain of the amplifier. The TDD amplifier includes some or all the functions of a client node to monitor network MAPs and traffic to control the amplifier.

In one embodiment, a WAN has the network controller (NC) in a fixed location, towards the cable head end and away from client nodes located inside buildings, also called terminal nodes. The TDD amplifier direction is switched based on the schedule of transmissions from the NC or to the NC.

When a client or NC is transmitting, not all TDD amplifiers installed in the cable plant will necessarily be in the transmission path. Some TDD amplifiers are used only for far away points and are not in the path for closer clients. In this case, the TDD amplifiers that are not in the direct path of communication can be switched away from the intended receiver so that output noise of unneeded TDD amplifiers is not contributing noise to the intended receiver.

In the WAN case, the direction of the amplifier can be solely based on if the NC is transmitting or not. In another embodiment, a LAN has an NC that can be within the node space and can be mobile; also, node-to-node communications must pass through the amplifier. The switch controller detects the location of the NC and direction of other scheduled transmissions and switches according to the scheduling.

### BRIEF DESCRIPTION OF THE DRAWINGS

FIG. 1 shows a diagram of a cable plant used for network access to a home.

FIG. 2 shows a TDD amplifier and control circuitry.

FIG. 3 shows a switchable RF amplifier with switchable direction of amplification for use in a TDD amplifier.

FIG. 4 shows an alternate switchable RF amplifier configuration for a TDD amplifier.

FIG. 5 shows a 4-channel TDD amplifier.

FIG. 6 shows a TDD amplifier for use in a home installation.

### DETAILED DESCRIPTION OF THE INVENTION

### WAN/Access Embodiment

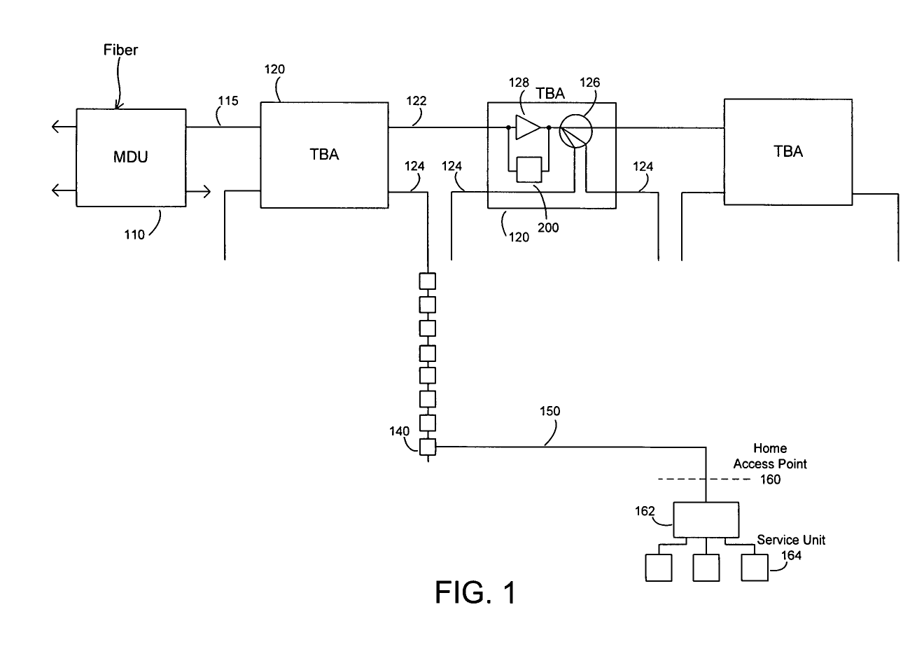

FIG. 1 shows a diagram of a cable plant used for network access to a home. A multiple distribution unit (MDU) 110 converts between fiber optical signals and coaxial cable (coax) electrical signals. The MDU 110 drives cable segments 115, typically ranging from 150 to 300 meters in length, to trunk bridge amplifiers (TBA) 120. The MDU can have multiple outputs connected to multiple TBAs. The TBA has amplifier 128 to amplify cable television signals, output 122 to drive additional downstream TBAs, and high power outputs 124 to drive the coax providing cable signals to a neighborhood, typically up to 300 meters.

Taps 140, connections to access the cable signal, are distributed along the coax connected to TBA outputs. Although called TBA outputs, referencing legacy cable system television signal flow, signals flow both in and out of these TBA ports. Drops 150 are coaxial cables connected to the taps and run to individual homes. An access point 160 at the home enables customer access to the cable connection for distribution inside the home. A splitter 162 divides the downstream signal and sums the upstream signals for distribution to and from individual service units 164, which can be televisions, cable set-top boxes (STBs), or network nodes.

A time division duplex (TDD) amplifier 200 is needed in the cable plant to amplify the network signals in both the upstream and downstream directions. The TDD amplifier 200 is installed in the cable wiring in series with the cable signal flow on the TBA outputs. Splitter/coupler 126 provides a connection to the neighborhood cable outputs. TDD amplifier 200 can be installed in parallel with cable signal amplifier 128 to amplify network signals flowing in the cable system through the TBAs. Network signals are amplified that drive to the client nodes and also from the client nodes to the NC node. Alternate configurations are possible; one example is to connect a TDD amplifier in series with the neighborhood cable outputs.

The TDD amplifiers are preferably installed in the TBAs. MDUs house the NCs. The MDU will house the NC or multiple NCs if more than one network channel is used.

The NC in the WAN transmits MAP messages that are decoded by the controller and the RF amplifier is switched to the proper direction based on the schedule of transmissions to and from the NC.

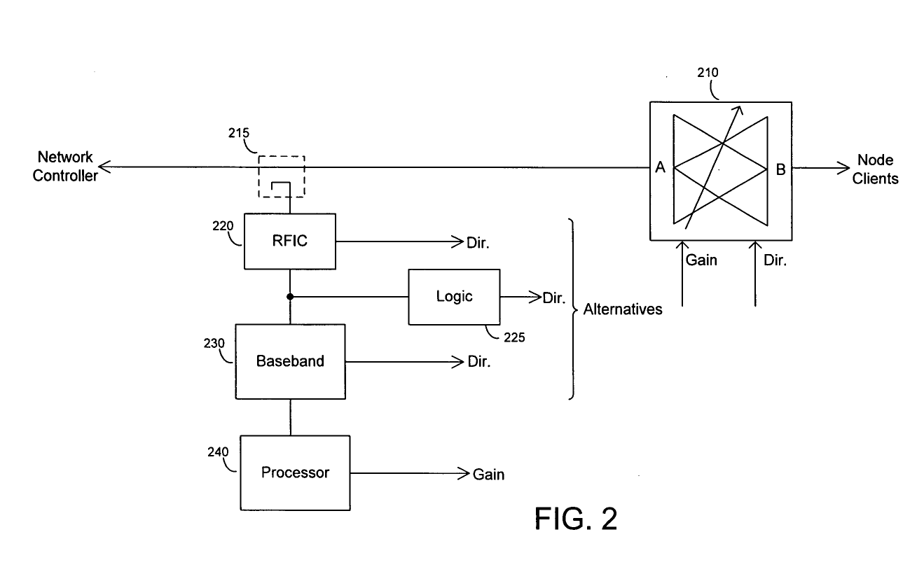

FIG. 2 shows a TDD amplifier and control circuitry. A TDD amplifier comprises a direction-switchable RF amplifier 210, and control circuitry to select the direction and gain of the amplifier.

The network controller (NC) location that provides the reference for signal flow direction is known; it is upstream from the client nodes. The signal on the NC side of the amplifier is monitored using a coupler 215, splitter, or other well-known techniques. The radio frequency integrated circuit (RFIC) 220 receives the signal being monitored. Filtering, automatic gain control (AGC), amplification, and other processing is done on the RF signal. The processed RF signal is passed to the baseband IC 230. Control signals and RF data flow between the RFIC and the baseband device. The RF signal is digitized either in the RFIC or baseband IC. The baseband IC demodulates the signal and extracts the digital message information sent from the NC. A host processor can further process the signal parameters of the received signal, including determining the gain level to set on the TDD amplifiers. The direction control on the RF amplifier 210 can be driven from either the RFIC 220, the baseband device 230, or logic 225 that monitors the signals between the RFIC and the baseband device. The TDD amplifier includes some or all the functions of a client node to monitor network MAPs and traffic to control the amplifier.

The network communication protocol can be based on frames. Each frame includes a MAP that announces the schedule within the next frame for all transmissions on the channel. Implicit or explicit in the schedule is identification of the device transmitting and therefore determines the direction of the signal flow and amplification required by the TDD amplifier. The MAP information can be contained in a special message that describes the state of the network. The TDD amplifier controller detects the frames and decodes the MAP information transmitted by the NC. The frame comprises time slots for each node transmission according to the MAP schedule. Between each transmission slot, an inter-frame gap is provided to allow time for the transmitter and receiver circuitry of nodes to switch.

In the WAN mode, the TDD amplifier is inserted in-line with the path between some of the node clients and the network controller. Additionally, clients can be connected directly to the MDU or its secondary or distribution port. The direction control of the switch is set according to the decoded MAP and the transmission direction required by the location of the transmitting device. If the MAP indicates the transmission is from the NC, the direction of the TDD amplifier is switched to amplify in the direction from the NC to the node clients.

The level of output signal can be different for each direction of the TDD amplifier. A gain control can be used to adjust the gain of the amplifier and therefore the output signal level to achieve the required signal level in each direction. Alternatively, a gain control can be used to adjust the gain of the amplifier for both directions.

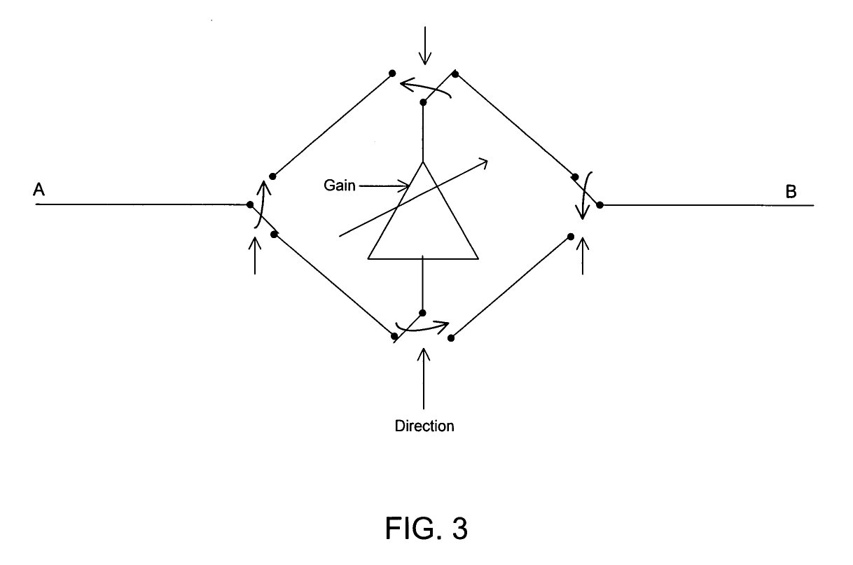

FIG. 3 shows an amplifier with switchable direction of amplification for use in a TDD amplifier. All switches switch with a single control signal. The signal flow is in the direction of A to B as shown. With all switches in the alternate position, the signal flow is in the direction of B to A. The amplifier has a gain control to set the output signal level, which can be set differently for each direction.

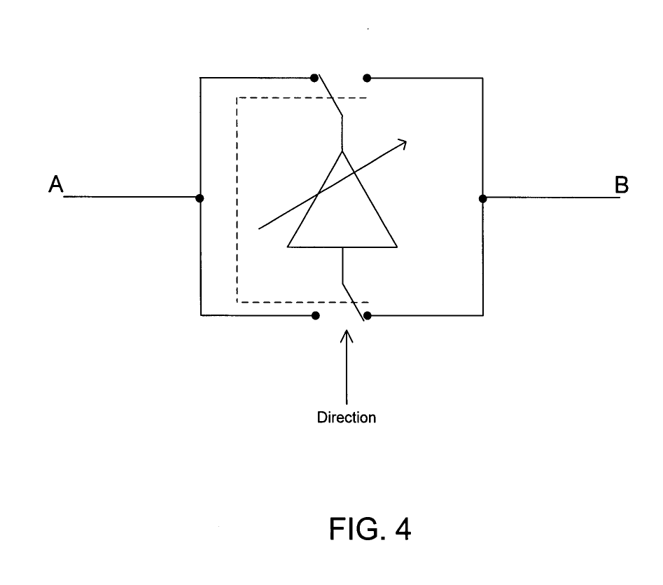

FIG. 4 shows an alternate switch configuration for a TDD amplifier. This configuration reduces components but may compromise on isolation or well controlled return loss.

In general, network devices can be frequency agile and the network can utilize a band of frequencies within a wider band allocated for use by several networks. For example, the network can use a bandwidth of 50 MHz set anywhere within a range of frequencies from 1000 MHz to 1500 MHz. There may be several non-contiguous bands allocated for use by networks. Each network operating at a different center frequency can be independent or synchronized with other networks on other channels and requires TDD amplifier direction switching specific to the traffic on the network.

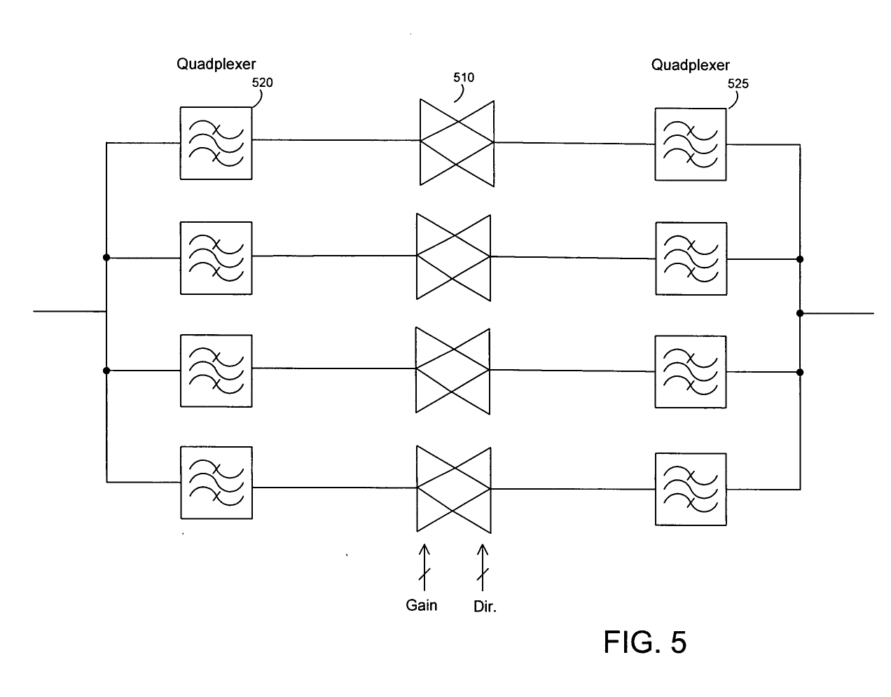

FIG. 5 shows a multi-channel TDD amplifier with quadplexers at the input/output ports and individual switchable amplifiers operating on different bands of frequencies. Each switchable amplifier 510 has bandpass filters 520 and 525 to pass frequencies of one network. The bandpass filters 520 form a quad-plexer at one port, and bandpass filters 535 form a quadplexer at the other port of the multi-channel TDD amplifier. The bandpass filters combine and split the signal into four signal bands, each band carrying independent network signals.

Each amplifier and switch has an independent gain and direction control operated by a corresponding controller. In general, the frequency bands are non-overlapping. The multi-channel TDD amplifier can be extended to have greater or fewer independent channels. The bandpass filters can be ceramic, surface acoustic wave (SAW) filters, or other known filter types.

In a data access network that deploys multiple access networks on one coax, each operating on a different frequency, in order to simplify the design of a TDD amplifier, upstream and downstream transmissions between different access networks can be coordinated. Transmissions in the access networks sharing a coax must be coordinated in time such that when one or more NC's are transmitting, no clients on any network are transmitting. By doing this, at any given time the transmissions on the coax wire are always traveling in the same direction (either upstream or downstream). This causes all data transmissions on all channels to require amplification in the same direction at the same time.

By coordinating transmissions between all the access networks, a single TDD amplifier with no bandpass filter bank can be used to amplify signals on all the networks. The access NC's must all be collocated on one side of the TDD amplifier.

When any or all NCs are transmitting downstream, the TDD amplifier is switched to amplify from the NCs to the clients. During other times, the TDD amplifiers in the path between the client and NC are switched to amplify in the direction from the clients to the NC.

Upstream and downstream transmission times can be selected to accommodate the longest time needed by any of the NCs. A fixed or adaptive allocation of upstream and downstream times can be established based on the traffic over the networks.

### LAN/In-Home Embodiment

Home cable distribution systems often use RF amplifiers to compensate for losses in cabling and splitters. These amplifiers boosts the cable signal strength at devices located where there would otherwise be intolerable signal loss. It is desirable that network devices work in amplified cable distribution networks but two problems may prevent this:

1. When amplifiers are present, the attenuation of network signals through the amplifier may be excessive. This is especially true when network signals must travel backwards (e.g. from output to input) through the amplifier.

2. When amplifiers are present, the passive cable and splitter losses for normal cable signal frequencies (e.g. <860 MHz) are generally high and the losses for network frequencies, which are >860 MHz, will be even higher and may even be excessive.

In order to overcome these two issues, a network amplifier may be necessary. A network amplifier must amplify the network bi-directional Time Division Duplex (TDD) signals. Ideally, a network TDD amplifier will be designed to include the functionality of a conventional cable RF amplifier so that the combined amplifier can be used as a replacement for existing conventional RF amplifier and amplify both network and standard cable frequencies.

Since network frequencies have higher loss than standard cable frequencies, network amplifiers may also be useful in homes that do not need RF amplifiers for standard cable frequencies.

Operation

Network nodes use TDD to send bi-directional traffic across a home cable distribution plant. In order to amplify a network signal, the amplifier must be capable of amplifying the TDD signals between two ports in either direction. Although there may be amplifier designs which provide simultaneous gain between both ports, these designs will be susceptible to instability that can result in oscillations. The network TDD Amplifier proposed here decodes network signals and uses MAPS to determine which port the source of the transmission is coming from and switches the direction of an RF amplifier such that the source is amplified. The direction of amplification is thus dynamically switched between the two ports on a packet-by-packet basis. At any given instant, the gain of the RF amplifier is only unidirectional so oscillations can never occur.

The TDD amplifier determines the RF amplifier direction by:

1. Registering itself as a network node and receiving MAPS from the NC.

2. Learning the other nodes on each of its two ports

3. Decoding MAPS and using the information to switch the direction of amplification

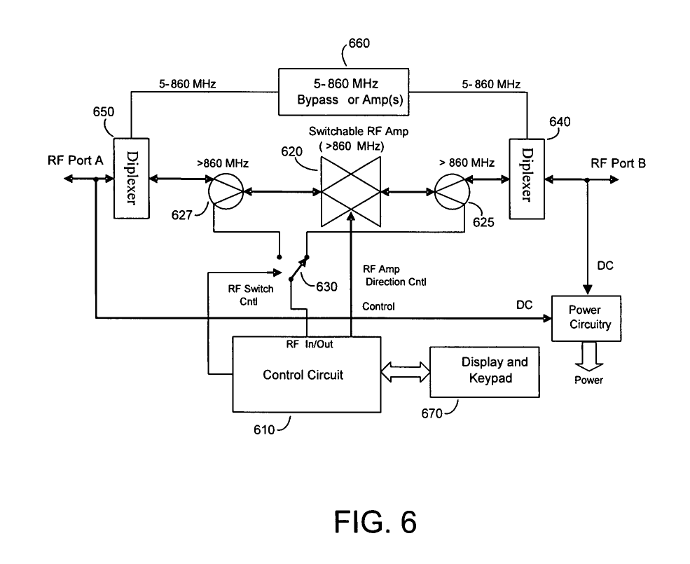

FIG. 6 shows a TDD amplifier for use in a home installation. The TDD amplifier control circuit 610 and RF switch 630 selectively monitors both ports of the RF amplifier 620 to detect beacon messages or MAPs to determine where the NC is located. After locating the NC and MAPs, the control circuit 610 can decode the MAP scheduling and signal activity determine the location of client nodes. Couplers 625 and 627 provide a monitoring point for the signals. The couplers can be directional couplers. Diplexers 640 and 650 on the input and output provide a frequency selective bypass for a band of frequencies, for example conventional cable television channels, that do not pass through the switchable RF amplifier 620. The bypass path circuitry 660 can be passive or active. A TDD amplifier can further comprise a keypad and display for configuration and status of the unit.

Finding the Network Coordinator & Admission

In order for the TDD amplifier to operate, the TDD amplifier must obtain admission to the network and must therefore find the Network Coordinator. The TDD amplifier must search for the Network Coordinator by:
Performing frequency scanning as a normal node.
During scanning—using the RF switch to listen on Port A and then B for Beacons.
After finding Beacons perform normal synchronization and admission with the Network Coordinator.

After this, the TDD amplifier will be treated as a node on the network and receive MAPS just as any active node. The TDD amplifier must not try to become Network Coordinator.

Channel Scanning

As long as a TDD amplifier is not admitted to a network, the TDD amplifier must attempt to find an existing network by scanning different RF channels and listening for Beacons. If a Beacon is found, the TDD amplifier must attempt to join that network. If a Beacon is not found, the TDD amplifier must continue its search and must NOT try to start a new network by becoming Network Coordinator. As described here, a TDD amplifier would transmit on both ports at the same time. If the TDD amplifier become an NC, the TDD amplifier would need to transmit on both ports. There could be some benefit to allow the TDD amplifier to become NC but this would add more cost to the device because it would require more software.

Last Operational Frequency (LOF)

The “last operational frequency” (LOF) is the frequency of the latest RF channel on which the TDD amplifier has successfully has been admitted into a network. In order to facilitate robust recovery from resets and failures, the “last operational frequency” must be stored in the TDD amplifier's non-volatile memory and when channel scanning, the TDD amplifier must try the LOF before searching other RF frequencies for Beacons. While scanning for RF channels, a TDD amplifier should retry the LOF between every other scanned RF frequency, this is to facilitate a fast recovery.

Admission of Remote Nodes

Remote nodes are defined as the nodes at locations that would be disadvantaged without an amplifier. If there is more than one remote node, there is the danger that before the TDD amplifier is admitted and registered with the NC, the remote nodes have formed a network of their own TDD amplifier. To avoid the formation of multiple networks, if there is more than one remote node, the following should be practiced after installing a TDD amplifier:

1. Power down the remote nodes

2. Power up the TDD amplifier and all other nodes besides the remote nodes, allow some time for them to form a network

3. Power up remote nodes one by one

The process described here will guarantee that the remote nodes come up and join the network one at a time.

An alternative to prevent multiple networks is for the TDD amplifier to jam” one port momentarily, for example for approximately 0.1 sec, to force nodes to reset and search for the NC. One way this could be implemented is as follows:

1. All nodes in the house are configured for fixed frequency operation. This prevents multiple networks for forming on different frequencies.

2. When searching for a network the TDD amplifier checks RF Ports A and B alternately and tries to join the network of any beacon it finds.

3. Once the TDD amplifier joins a network on one RF port, it will jam the other RF Port with a signal on the tuned MoCA frequency for a period of >0.1 seconds so as to disrupt any existing network. A wideband jamming signal can also be used to jam the entire MOCA band.

4. During the jamming operation, the TDD amplifier must only inject the jamming signal on the RF port on which is it trying to disrupt. The other port is allowed to continue network communications.

5. After jamming a RF Port, the TDD amplifier can begin normal operation, transfer communications from one port to the other and allow all nodes to form into a common network.

Another method to resolve multiple networks would be to include two TDD amplifiers that simultaneously monitor both RF Ports for beacons. If beacons are heard on both ports, the TDD amplifier can chose to jam one of the ports as described above.

Note that with NC election, a process by which the NC is transferred to the optimum physical location, it is not critical which node on which RF Port initially becomes Network Coordinator of the network since the election process will move the NC to the best location.

A new protocol message could also be included in the network devices that can be sent by a TDD amplifier to all the nodes in a network instructing them to dissolve the network, subsequently enabling a new combined network to form through the TDD amplifier.

Topology Learning

In order for a TDD amplifier to switch gain directions, it must learn which devices are attached to its ports. There are many different ways this can be done. One possible way is for the TDD amplifier to follow these steps:
Decode the MAP to learn nodes on network.
Listen on Port A or B for Reservation Request messages and learn the Port locations of nodes.

What is claimed is:

1. A time division duplex (TDD) amplifier with two ports for amplifying signals in a wired network passing between the ports comprising:
a switchable RF amplifier capable of having the direction of amplification switched, coupled between the two ports;
a switch controller for the RF amplifier, the controller capable of monitoring the network communication to determine the direction of scheduled signal transmissions and switch the amplifier direction according to the direction of signal transmissions.

2. The amplifier of claim 1 wherein the switchable amplifier comprises:
a radio frequency (RF) signal amplifier;
switches that connect to the amplifier that determine the direction of amplification between the ports.

3. The amplifier of claim 1 wherein the network communication that provides direction information is a media access plan (MAP) that contains schedules of time slots within a frame cycle for each transmission.

4. A network using a TDD amplifier of claim 1 wherein the network communication comprises a media access plan (MAP) transmitted from a network controller that contains schedules of time slots within a frame cycle for each transmission and the TDD amplifier direction is switched according to the MAP information.

5. A network using a TDD amplifier of claim 1 and a network controller that transmits a bit for each scheduled transmission that indicates the direction of signal flow for each transmission and the TDD amplifier direction is switch according to the bit.

6. The amplifier of claim 1 further comprising:
a bypass circuit;
frequency selective filters coupled to the bypass circuit and the RF amplifier that passes one band of frequencies to the switchable RF amplifier and a second band of frequencies to the bypass circuit, whereby the second band of frequencies is not amplified by the switchable RF amplifier.

7. The amplifier of claim 6 wherein the bypass circuit is an amplifier for amplifying a band of frequencies.

8. A multi-channel time division duplex (TDD) amplifier comprising:
a plurality of direction switchable radio frequency (RF) amplifiers;
a plurality of frequency selective filters coupled to the RF amplifiers for selecting a band of frequencies for each RF amplifier;
control circuitry to monitor signals at the switchable RF amplifiers and control the direction of amplification of the RF amplifiers.

9. The amplifier of claim 8 wherein each switchable RF amplifier is independently switched by monitoring network communication at each switchable RF amplifier.

10. The amplifier of claim 8 wherein the switching of each switchable RF amplifier is synchronized so all switchable RF amplifiers switch together.
